(19) United States
(12) Patent Application Publication
(10) Pub. No.: US 2008/0293883 A1
(43) Pub. Date: Nov. 27, 2008

(54) Process for Production of (Co)Polyamide Nanocomposite Materials

(75) Inventors: Bernard Pees, Beaumontel (FR); Marc Audenaert, Bernay (FR); Maliha Khusrawy, Bernay (FR); Helene Egret, Rouen (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Puteaux (FR)

(21) Appl. No.: 11/718,041

(22) PCT Filed: Oct. 26, 2005
(86) PCT No.: PCT/EP2005/012743

§ 371 Date: Aug. 4, 2008

Related U.S. Application Data
(60) Provisional application No. 60/647,360, filed on Jan. 26, 2005.

(30) Foreign Application Priority Data
Oct. 27, 2004 (JP) 313161/04

(51) Int. Cl. C08L 77/00

(52) U.S. Cl. 524/606; 977/788

(57) ABSTRACT

The present invention concerns a process for preparing a polymer nanocomposite composition, the process comprising: a) mixing a melted polyamide of inherent viscosity under 1 and a nanofiller to disperse the nanofiller in said polyamide; and b) subjecting the previous mixture to polymerization conditions to polymerize the polyamide and to form the polymer nanocomposite composition. Advantageously the inherent viscosity of the polyamide is under 0.9 and preferably between 0.4 and 0.8. Step a) is carried out in an extruder or a mixer. Advantageously a mono or twin-screw extruder is used. Step b) could be made either in melted state or in solid state. It is easier to make it in the same apparatus as step a). Should step a) is carried out in an extruder, step b) is made in the same extruder. Polymerization of step b) can be carried with a catalyst and/or by having the extruder zones in which step b) takes place to operate under vacuum.

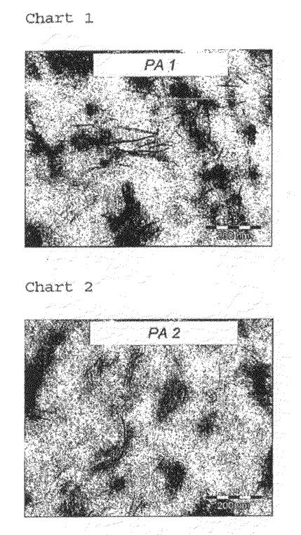

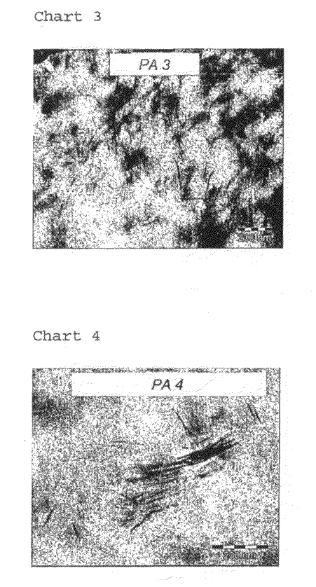

### FIELD OF THE INVENTION

The present invention concerns a process for production of (co)polyamides composites materials and more particularity (co)polyamides containing dispersed nanofillers.

### PRIOR ART AND TECHNICAL PROBLEM

EP 1 405 874 provides a process for producing a polyamide composite material comprising a polyamide A1, a polyamide A2, each being produced by polycondensing a diamine component containing 70 mol % or higher of m-xylylenediamine with a dicarboxylic acid component containing 50 mol % or higher of a C4 to C20 alpha, omega-linear aliphatic dicarboxylic acid, and an organized clay B, by using a corotating intermeshing twin-screw extruder in which at least a feed section (a) with a feed port (a), a kneading section (a) having a high dispersive mixing capability, a feed section (b) with a feed port (b) and a kneading section (b) having a high distributive mixing capability are arranged in this order, the process comprising:

a step of feeding the polyamide A1 containing a phosphorus compound in an amount of 500 ppm or smaller in terms of phosphorus atom and having a relative viscosity of 1.1 to 4.7 and the organized clay B into the feed section (a) through the feed port (a);
a step of melt-kneading the polyamide A1 and the organized clay B substantially by dispersive mixing in the kneading section (a) to obtain a melt-knead product;
a step of transporting the melt-knead product from the kneading section (a) to the feed section (b), simultaneously feeding the polyamide A2 having a relative viscosity of 2.0 to 4.7 into the feed section (b) through the feed port (b); and
a step of melt-kneading the melt-knead product and the polyamide A2 each from the feed section (b) substantially by distributive mixing in the kneading section (b) to prepare the polyamide composite material.

It is explained in the description that the concentration of the phosphorus compound in the polyamides A1 and A2 is preferably 1 to 500 ppm, more preferably 350 ppm or lower and still more preferably 200 ppm or lower in terms of phosphorus atom. If exceeding 500 ppm, no additional effect of preventing the discoloration is obtained, instead, the haze of films produced from the polyamide composite material is increased.

In example 1 PA1 of relative viscosity 2.56 is fed to the twin-screw extruder at 6.12 kg/h with 2.04 kg/h of clay; then PA2 of relative viscosity 2.5 is fed to the twin-screw extruder at 51.84 kg/h; a polyamide composite of relative viscosity 2.50 is obtained. There is no viscosity increase. The phosphorous compound at 500 ppm in A1 has no effect in viscosity increase, purpose of the phosphorus compound is to enhance a processing stability during the melt molding and prevent the discoloration of the polyamides A1 and A2.

WO 99-41060 relates to a process to prepare the above polymer nanocomposite composition comprising forming a flowable mixture of a polyamide and a silicate material and dissociating (as that term is described in more detail below) at least about 50% but not all of the silicate, and subjecting the polyamide in the dissociated flowable mixture to a solid state polymerization step. All the examples are directed to PA 6.6. The polyamide to be mixed with the silicate material has an intrinsic viscosity of 1.33 to 1.38. As to the solid state polymerization (of the mixture PA+silicate) examples show intrinsic viscosity increase from 1.67 to 2.5, from 1.67 to 2.73 and 1.63 to 2.05.

Inventors have discovered that to get a better dispersion of the nanofillers the polyamide have to be of low viscosity, for example in the range 0.4 to 1. Then the resulting mixture of polyamide and nanofillers is subjected to a further polymerization step.

### BRIEF DESCRIPTION OF THE INVENTION

The present invention concerns a process to prepare a polymer nanocomposite composition, the process comprising:

a) mixing a melted polyamide of inherent viscosity under 1 and a nanofiller to disperse the nanofiller in said polyamide; and
b) subjecting the previous mixture to polymerization conditions to polymerize the polyamide and to form the polymer nanocomposite composition.

Advantageously the inherent viscosity of the polyamide is under 0.9 and preferably between 0.4 and 0.8.

Step a) is made in an extruder or a mixer. Advantageously a mono or twin-screw extruder is used. Step b) could be made either in melted state either in solid state. It is easier to make it in the same apparatus as step a). Should step a) is made in an extruder, step b) is made in same extruder.

Polymerization of step b) can be made with a catalyst and/or by having the extruder zones in which step b) is made to operate under vacuum. Catalyst could be introduced in step a) or in step b). It could also be inherently contained in the polyamide because it is a residue of the catalyst used to make the polyamide.

The nanofiller is advantageously a layered or lamellar silicate.

Advantages of the invention are:

(co)polyamides nanocomposites can be obtained with a complete dissociation of the nanofiller;
viscosity can be chosen by adjusting step b);
good dispersion of the nanofillers;
no specific apparatus is required, an usual extruder or mixer can be used;
complete dissociation of the nanofiller is obtained in the course of the process.

### DETAILED DESCRIPTION OF THE INVENTION

As regards the catalyst it is a polycondensation catalyst such as a mineral or organic acid, for example phosphoric acid.

It is recommended to dry the polyamides thoroughly (and advantageously to control the moisture levels carefully) in order to avoid depolymerizations. The amount of catalysts may be between 5 ppm and 15 000 ppm relative to the polyamide. Preferably, this is phosphoric or hypophosphoric acid. The amount of catalyst may be up to 3000 ppm, and advantageously between 200 and 4500 ppm, and much better between 550 and 4500 ppm relative to the amount of polyamide. For other catalysts, for example boric acid, the contents will be different and may be chosen appropriately according to the usual techniques for the polycondensation of polyamides.

As regards the polyamides, the term polyamide refers to the condensation products:
of one or more amino acids, such as aminocaproic, 7-aminoheptanoic, 11-aminoundecanoic and 12-aminododecanoic acid, or of one or more lactams such as caprolactam, oenantholactam and lauryllactam;
of one or more salts or mixtures of diamines such as hexamethylenediamine, dodecamethylenediamine, metaxylylenediamine, bis(p-aminocyclohexyl)methane and trimethylhexamethylenediamine with diacids such as isophthalic, terephthalic, adipic, azelaic, suberic, sebacic and dodecanedicarboxylic acid.

Examples of polyamides that may be mentioned include PA 6, PA 6-6, PA 11 and PA 12.

It is also possible to make advantageous use of copolyamides. Mention may be made of the copolyamides resulting from the condensation of at least two alpha,omega-amino carboxylic acids or of two lactams or of one lactam and one alpha,omega-amino carboxylic acid. Mention may also be made of the copolyamides resulting from the condensation of at least one alpha,omega-amino carboxylic acid (or one lactam), at least one diamine and at least one dicarboxylic acid.

Examples of lactams which may be mentioned include those having 3 to 12 carbon atoms on the main ring, which lactams may be substituted. Mention may be made, for

example, of β,β-dimethylpropiolactam, α,α-dimethylpropiolactam, amylolactam, caprolactam, capryllactam and lauryllactam.

Examples of alpha,omega-amino carboxylic acids that may be mentioned include aminoundecanoic acid and aminododecanoic acid. Examples of dicarboxylic acids that may be mentioned include adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids having a dimer content of at least 98% and preferably being hydrogenated) and dodecanedioic acid, HOOC—(CH₂)₁₀—COOH.

The diamine can be an aliphatic diamine having 6 to 12 carbon atoms; it may be of aryl and/or saturated cyclic type. Examples that may be mentioned include hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4-aminocyclohexyl)methane (BMACM).

Examples of copolyamides that may be mentioned include copolymers of caprolactam and lauryllactam (PA 6/12), copolymers of caprolactam, adipic acid and hexamethylenediamine (PA 6/6-6), copolymers of caprolactam, lauryllactam, adipic acid and hexamethylenediamine (PA 6/12/6-6), copolymers of caprolactam, lauryllactam, 11-aminoundecanoic acid, azelaic acid and hexamethylenediamine (PA 6/6-9/11/12), copolymers of caprolactam, lauryllactam, 11-aminoundecanoic acid, adipic acid and hexamethylenediamine (PA 6/6-6/11/12), and copolymers of lauryllactam, azelaic acid and hexamethylenediamine (PA 6-9/12).

Advantageously the copolyamide is chosen from PA 6/12 and PA 6/6-6.

It is possible to use polyamide blends.

There will be no departure from the framework of the invention on replacing part of the polyamide with a polyamide block and polyether block copolymer, that is to say on using a mixture comprising at least one of the previous polyamides and at least one polyamide block and polyether block copolymer.

The polyamide block and polyether block copolymers result from the copolycondensation of polyamide sequences having reactive ends with polyether sequences having reactive ends, such as, inter alia:
1) Polyamide sequences having diamine chain ends with polyoxyalkylene sequences having dicarboxylic chain ends.
2) Polyamide sequences having dicarboxylic chain ends with polyoxyalkylene sequences having diamine chain ends obtained by cyanoethylation and hydrogenation of aliphatic dihydroxylated alpha-omega polyoxyalkylene sequences called polyether diols.
3) Polyamide sequences having dicarboxylic chain ends with polyether diols, the products obtained being, in this particular case, polyether-esteramides. These copolymers are advantageously used.

The polyamide sequences having dicarboxylic chain ends are obtained, for example, from the condensation of alpha-omega aminocarboxylic acids, lactams or dicarboxylic acids and diamines in the presence of a chain regulator dicarboxylic acid.

The polyether may be for example polyethylene glycol (PEG), a polypropylene glycol (PPG) or a polytetramethylene glycol (PTMG). The latter is also called polytetrahydrofuran (PTHF).

The number-average molar mass M̅n̅ of the polyamide sequences is between 300 and 15 000 and preferably between 600 and 5 000. The mass M̅n̅ of the polyether sequences is between 100 and 6 000, and preferably between 200 and 3 000.

The polyamide block and polyether block polymers may also comprise randomly distributed units. These polymers can be prepared by the simultaneous reaction of the polyether and the precursors of the polyamide blocks.

For example, it is possible to react polyether diol, a lactam (or an alpha-omega amino acid) and a chain regulator diacid in the presence of a small amount of water. A polymer is obtained which essentially has polyether blocks, polyamide blocks of widely varying length, but also the various reagents having randomly reacted which are randomly distributed along the polymer chain.

Whether these polyamide block and polyether block polymers are obtained from the copolycondensation of polyamide and polyether sequences prepared beforehand or from a single step reaction, have for example Shore D hardness which may be between 20 and 75, and advantageously between 30 and 70, and an inherent viscosity between 0.8 and 2.5, measured in metacresol at 250° C. for an initial concentration of 0.8 g/100 ml. The MFIs may be between 5 and 50 (235° C. under a load of 1 kg)

The polyether diol blocks are either used as they are and copolycondensed with polyamide blocks having carboxylic ends, or they are aminated so as to be converted to polyether diamines and condensed with polyamide blocks having carboxylic ends. They can also be blended with polyamide precursors and a chain regulator in order to make polyamide block and polyether block polymers having randomly distributed units.

Polyamide and polyether block polymers are described in U.S. Pat. No. 4,331,786, U.S. Pat. No. 4,115,475, U.S. Pat. No. 4,195,015, U.S. Pat. No. 4,839,441, U.S. Pat. No. 4,864,014, U.S. Pat. No. 4,230,838 and U.S. Pat. No. 4,332,920.

The ratio of the quantity of polyamide block and polyether block copolymer to the quantity of polyamide is, by weight, advantageously between 10/90 and 60/40. Mention may be made, for example, of the blends of (i) PA 6 and (ii) PA 6 block and PTMG block copolymer and blends of (i) PA 6 or PA 12 and (ii) PA 12 block and PTMG block copolymer.

mention may be made also of copolyamide of formula X/Y,Ar in which:
Y denotes the residues of an aliphatic diamine having from 8 to 20 carbon atoms,
Ar denotes the residues of an aromatic dicarboxylic acid,
X denotes either the residues of aminoundecanoic acid NH₂—(CH₂)₁₀—COOH, of lactam-12 or of the corresponding amino acid, or X denotes the unit Y,x, residue from the condensation of the diamine with an aliphatic diacid (x) having between 8 and 20 carbon atoms, or X denotes the unit Y,I, residue from the condensation of the diamine with isophthalic acid,

Preferably, X/Y,Ar denotes:
11/10,T, which results from the condensation of aminoundecanoic acid, 1,10-decanediamine and terephthalic acid,
12/12,T, which results from the condensation of lactam-12, 1,12-dodecanediamine and terephthalic acid,
10,10/10,T, which results from the condensation of sebacic acid, 1,10-decanediamine and terephthalic acid,
10,I/10,T, which results from the condensation of isophthalic acid, 1,10-decanediamine and terephthalic acid.

mention may be made also of polyamide of formula X.Y/Z ou 6.Y2/Z in which:

X denotes the residues of an aliphatic diamine having 6 to 10 carbon atoms,
Y denotes the residues of an aliphatic diacide having 10 to 14 carbon atoms,
Y2 denotes the residues of an aliphatic diacide having 15 to 20 carbon atoms,
Z denotes at least a unit chosen among the residue of a lactam, the residue of an alpha-omega aminocarboxylic acide, the unit X1.Y1 in which X1 denotes the residue of an aliphatic diamine and Y1 denotes the residue of an aliphatic dicarboxylic acide,
the weight ratios Z/(X+Y+Z) and Z/(6+Y2+Z) are between 0 and 15%.

The polyamide may also contain a plasticizer.

As regards the plasticizer, this is chosen from benzenesulphonamide derivatives, such as N-butylbenzenesulphonamide (BBSA), ethyetoluenesulphonamide or N-cyclohexyltoluenesulphonamide; esters of hydroxybenzoic acids, such as 2-ethylhexyl-parahydroxybenzoate and 2-decylhexyl-para-hydroxybenzoate; esters or ethers of tetrahydrofurfuryl alcohol, like oligoethyleneoxytetrahydrofurfuryl alcohol; and esters of citric acid or of hydroxymalonic acids, such as oligoethyleneoxy malonate. A particularly preferred plasticizer is N-butylbenzenesulphonamide (BBSA). It would not be outside the scope of the invention to use a mixture of plasticizers.

The plasticizer may be introduced into the polyamide during the polycondensation or later.

The amount of polyamide is advantageously between 72 and 92% for 28 to 8%, respectively, of the sum of the amount of plasticizer.

As regards the nanofiller and particularly the layered or lamellar silicate used in this invention this is a substance having a structure comprising crystalline layers (silicate layers) made mainly of silicate and charged in the negativity and cation which lies in the intercalation of the crystalline layers and which have a predetermined ion exchange capacity. The silicate layer is an elemental or unit which constitutes the layered silicate and is a flake-like inorganic crystal obtained when the layer structure of layered silicate is destroyed (“cleavage” hereinafter). The “silicate layer” used in this invention is understood as each flake of this layer or a lamination condition of less than 5 layers in average.

Term “dispersed uniformly” in this invention is understood that each silicate layer exists without forming a lump or block in substantially separate condition when the silicate layers are dispersed in the resin matrix. Such condition can be confirmed by observing a transmission electron microscope photograph of a test piece of resin composition, for example. The interlayer distance is a distance between centers of gravity of the silicate layers.

The silicate layers are dispersed in “molecular level”. This is understood that each silicate layer keeps an interlayer distance over 2 nm in average without forming a lump or block, when the silicate layers are dispersed in the resin matrix. The interlayer distance is a distance between centers of gravity of the silicate layers. Such condition can be confirmed by observing a transmission electron microscope photograph of a test piece of resin composition, for example.

The layered silicate is natural and artificial silicates and may be smectite group (montmorillonite, beidellites, hectorites, soconite etc), vermiculite group (vermiculite etc), mica group (fluoromica, muscovite, paragonite, phlogopite, lepidolite, etc), fragile mica group (margarite, clintonite, anandite etc), and chlorite group (donbassite, sudoite, cookeite, clinochlore chamosite, nimite etc). In this invention, swellable fluorine mica and montmorillonite are preferably used and swellable fluorine mica is more preferable due to its excellent brightness and its effect to improve of the rigidity.

The swellable fluorine mica is obtained by fusion method and by intercalation method and has a structure having following general formula:

Mₐ(Mg_{b}Li_{c})Si₄O₁₀F₂

in which
0<a≦1
2.5≦b≦3,
0≦c≦0.5,
a+b+2c=6
n is zero or positive integer, and
M is ion-exchangable cation such as sodium and lithium

The montmorillonite is obtained from natural product by refining of elutriation treatment and has a structure having following general formula:

MₐSi (Al₂₋ₐMg)O₁₀ (OH)₂nH₂O

in which

0.25≦a≦0.6

n is zero or positive integer,

M is ion-exchangable cation.

As the montmorillonite, existence of isomorphic ion substitutes such as magnesia montmorillonite, iron montmorillonite, iron magnesia montmorillonite or the like are known and these montmorillonites also may be used.

A proportion of the contents of the layered silicate is preferably in a range of 0.1 to 30% by weigh and more desirably 1 to 10% by weight in term of inorganic ash content which is an incineration residue of a polyamide resin composition. If the inorganic ash content is not higher than 0.1% by weight, improvement in rigidity of this invention can't be realized. On the other hand, if the inorganic ash content exceeds 30% by weight, the specific gravity increases and hence lightening of a product invention can't be realized and stiffness is lost sharply.

In this invention, it is preferable to contact the layered silicate with a swelling agent so that the interlayer distance is increased resulting in facilitate uniform dispersion of the silicate layers into the resin matrix. The swelling agent is preferably organic cation such as organic ammonium ion and organic phosphonium ion.

The organic ammonium ion may be primary to quaternary ammonium ions. The primary ammonium ion may be octyl ammonium, dodecil ammonium and octadecyl ammonium. The secondary ammonium ion may be dioctyl ammonium, methyloctadecyl ammonium and dioctadecyl ammonium. The tertiary ammonium ion may betrioctyl ammonium, dimethyldodecyl ammonium and didodecylmonomethyl ammonium. The quaternary ammonium ion may be tetraethyl ammonium, trioctylmethyl ammonium, octadecyltrimethyl ammonium, dioctadecyldimethyl ammonium, dodecyldihexylmethyl ammonium, dihydroxyethylmethyloctadecyl ammonium, methyldodecyl bis(polyethylene glycol) ammonium and methyldiethyl (polypropylene glycol) ammonium. The organic phosphonium ion may tetraethyl phosphonium, tetrabutyl phosphonium, tetrakis(hydroxymethyl)phosphonium and 2-hydroxyethyltriphenyl phosphonium. These chemicals can be used independently or can be used in combination of more than two compounds. Among them, ammonium ion is preferably used.

Contact between the layered silicate with a swelling agent can be effected by the steps of dispersing the layered silicate in a water or in alcohol, adding the organic cation in salt form under agitation to mixing them so that the inorganic ions in the layered silicate is ion-exchanged with the organic cation, followed by filtering, washing and drying steps.

The composition of the invention may also include additives such as antioxidants, UV stabilizers, pigments and other stabilizers. These products are known per se and are those normally used in polyamides. The amount of these additives may represent up to 5 parts and advantageously between 0.5 and 2 parts by weight per 100 parts of the combination of the polyamide, the plasticizer and the elastomer. The composition is usually recovered in the form of granules.

### EXAMPLES

We used the following products:
Nanomer 12-aminododecanoic acid modified
I.24TL: Montmorillonite clay gently provided by NANOCOR;
PA11-1: Catalyzed nylon-11 having a density of 1.030 g/cm³ and an ISO inherent viscosity of 0.8 dl/g;
PA11-2: Catalyzed nylon-11 having a density of 1.030 g/cm³ and an ISO inherent viscosity of 0.4 dl/g;
PA11-3: Catalyzed nylon-11 having a density of 1.030 g/cm³ and an ISO inherent viscosity of 1.35 dl/g;
Stab: system of “heat and light” stabilizing additives.

### Apparatus:

twin screw extruder co-rotative type HAAKE 16.

### Characterization

Ash content: is made by burning and treating the residue at 600° C. until a stable weight is obtained.
a distinction is made between the total weight of the nanofiller and the mineral content of the filler.
Transmission electron microscopy: Photos are made with ZEISS CEM 902 on samples made by ultra-microtomy a low temperature.
DMA.

In all the examples, the inherent viscosity was measured at 20° C. in a solution consisting of 5×10⁻³ g of polyamide per cm³ of meta-cresol. The corrected ISO value of the inherent viscosity was obtained using the following formula:

η_{ISO corrected}=η_{measured}×100/[(100%−x %)×1.034]

where x %=content of extractables and mineral.

### Example 1

The dry blend composition PA11-1 (94.8%), NANOMER I.24TL (4%) and stab (1.2%) was compounded in a WERNER® 30 (D/L=30)-type co-rotating twin-screw extruder, the feed zone was not heated and a 270° C. flat temperature profile was adopted for all the other zones. The screw profile is divided in four main zone: (1) the feed zone constituted of conveying elements; (2) the melting/intercalation zone constituted of kneading blocks plus reverse elements; (3) the degassing zone only constituted of conveying elements and equipped with a vacuum vent; (4) the last zone of the extruder, constituted of mixing and distributive elements, ensure the final dispersion of the platelets. With the highest vacuum level, the viscosity of the nylon PA1 obtained is 1.6. Chart 1 shows the platelets exfoliation.

The die exit extrusion rate was 20 kg/h for a screw rotation speed of 300 rpm (revolutions per minute). The rod was granulated after cooling in a water tank. The granules were then dried at 80° C. for 12 hours and packed in sealed bags after the moisture contents were checked (% water 0.08%).

### Example 2

The dry blend composition PA11-2 (94.8%), NANOMER I.24TL (4%) and stab (1.2%) was compounded in a CLEXTRAL BC21 (D/L=24)-type co-rotating twin-screw extruder, the feed zone was not heated and a 230° C. flat temperature profile was adopted for all the other zones. The description of the screw profile is the same as in example 1. The obtained tablets are crushed to a powder form before the solid-state viscosity increase step, which leads to the nylon 11 PA2, viscosity 1.3. The platelets exfoliation is shown on chart 2.

### Example 3

The dry blend composition PA11-2 (94.8%), NANOMER I.24TL (4%) and stab (1.2%) was compounded in the same conditions as in example 2. The obtained tablets are then introduced in a WERNER® 30 (D/L=30)-type co-rotating twin-screw extruder, the feed zone was not heated and a 270° C. flat temperature profile was adopted for all the other zones. The description of the screw profile and compounding conditions are the same as in example 1. Applying the highest vacuum level, the viscosity of the nylon PA3 obtained is 1.4. Chart 3 shows the platelets exfoliation.

### Example 4

The dry blend composition PA11-3 (94.8%), NANOMER I.24TL (4%) and stab (1.2%) was compounded in the same conditions as in example 1. Chart 4 shows that only partial exfoliation was obtained (remaining stacks).

1. Process to prepare a polymer nanocomposite composition, the process comprising:
a) mixing a melted polyamide of inherent viscosity under 1 and a nanofiller, in order to disperse the nanofiller in said polyamide; and
b) polymerizing the mixture formed in step a) to form the polymer nanocomposite composition.

2. Process according to claim 1 wherein the inherent viscosity of the polyamide is under 0.9.

3. Process according to claim 2 wherein the inherent viscosity of the polyamide is between 0.4 and 0.8.

4. Process according to claim 1 wherein step a) is made in an extruder or a mixer.

5. Process according to claim 1 wherein step b) is a polymerization in the melt state.

6. Process according to claim 5 wherein step b) is is a polymerization in the melt state in the same apparatus as step a).

7. Process according to claim 1 wherein polymerization of step b) is made with a catalyst.

8. Process according to claim 1 wherein the nanofiller is a layered or lamellar silicate.

9. Process according to claim 1 wherein polymerization of step b) has the extruder zones in which step b) is made to operate under vacuum.
